(19) United States
(12) Patent Application Publication
(10) Pub. No.: US 2017/0203770 A1
(43) Pub. Date: Jul. 20, 2017

(54) AUTOMATIC DRIVE ASSIST SYSTEM, AUTOMATIC DRIVE ASSIST METHOD, AND COMPUTER PROGRAM

(71) Applicant: AISIN AW CO., LTD., Anjo-shi, Aichi-ken (JP)

(72) Inventor: Yoshito KONDO, Okazaki (JP)

(73) Assignee: AISIN AW CO., LTD., Anjo-shi, Aichi-ken (JP)

(21) Appl. No.: 15/324,582

(22) PCT Filed: Jun. 12, 2015
(86) PCT No.: PCT/JP2015/066984

§ 371 Date: Jan. 6, 2017

(30) Foreign Application Priority Data
Jul. 25, 2014 (JP) 2014-151905

(51) Int. Cl. B60W 50/14; G01C 21/34; G05D 1/00

(52) U.S. Cl. CPC B60W 50/14; G05D 1/0088; G05D 1/0061; G01C 21/34; B60W 2520/10; B60W 2050/0002

(57) ABSTRACT

Automated drive assisting systems, methods, and programs acquire a non-execution reason, for which automated drive control cannot be executed, in the case where the automated drive control cannot be executed during travel in an automated drive section in which the automated drive control for a vehicle is permitted. The systems, methods, and programs provide guidance on the acquired non-execution reason, and determine whether or not the non-execution reason is a reason that is avoidable by a drive operation by a driver of the vehicle. The systems, methods, and programs provide, in the case where it is determined that the non-execution reason is a reason that is avoidable by a drive operation by the driver, guidance on a drive operation for avoiding the reason.

### TECHNICAL FIELD

Related technical fields include automated drive assisting systems, methods, and programs that assist a vehicle to travel through automated drive control.

### BACKGROUND

In recent years, many vehicles are provided with a navigation apparatus that provides travel guidance for the vehicle to allow a driver to easily reach a desired destination location. The navigation apparatus is a device that can detect the current position of the vehicle using a GPS receiver or the like and acquire map data corresponding to the current position from a storage medium such as a DVD-ROM or an HDD or through a network to display the map data on a liquid crystal monitor. Furthermore, such a navigation apparatus is provided with a route search function for searching for a recommended route from the vehicle position to a desired destination location when the destination location is input, and adapted to set the recommended route found in the search as a route for guidance, display the route for guidance on a display screen, and provide audio guidance in the case where the vehicle approaches an intersection or the like in order to reliably guide a user to the desired destination location. In recent years, in addition, some cellular phones, smartphones, tablet terminals, personal computers, and so forth also have functions that are similar to those of the navigation apparatus described above.

In recent years, in addition, there has been proposed, as a travel mode of a vehicle, travel through automated drive control in which the vehicle travels automatically along a route set in advance with no reliance on a drive operation by a user, besides manual travel in which the vehicle travels on the basis of a drive operation by the user. In the automated drive control, for example, the current position of the vehicle, the lane in which the vehicle travels, and the positions of other vehicles around the vehicle are detected at all times, and vehicle control for a steering unit, a drive source, a brake unit, and so forth is performed automatically such that the vehicle travels along the route set in advance. Although travel through the automated drive control is advantageous in that a burden related to drive on the user can be reduced, travel through the automated drive control may be difficult in some situations, depending on the road conditions and the surrounding environment. Examples of such situations include a situation where it is necessary to make a lane change or a lane merge in a short section and a situation in a bad weather. In such situations, it is necessary to suspend travel through the automated drive control and commence manual drive.

In the case where travel through the automated drive control is to be suspended, it is necessary for the user to travel through the manual drive after travel through the automated drive control is suspended, and thus it is necessary to provide the user with guidance indicating that travel through the automated drive control is to be suspended via the navigation apparatus or the like. For example, Japanese Patent Application Publication No. 2001-23094 (JP 2001-23094 A) proposes a technique of informing a driver that lane keeping travel, which is a type of automated drive control, has been suspended in the case where the lane keeping travel is suspended.

### SUMMARY

In the technique according to JP 2001-23094 A, however, guidance on the reason for which the automated drive control cannot be executed is not provided in the case where the automated drive control is suspended. Examples of the reason for which the automated drive control cannot be executed include a reason that is avoidable by a drive operation by the user and a reason that is caused only in a specific section, in addition to reasons that are never avoidable by the user such as a bad weather. Thus, suspension of the automated drive control can be avoided, or the period until the automated drive control is recovered next time can be shortened, depending on the reason for which the automated drive control cannot be executed.

With the technique according to JP 2001-23094 A, guidance on the reason for which the automated drive control cannot be executed is not provided, and thus the user cannot grasp the reason for which the automated drive control cannot be executed. If the user cannot grasp the reason, the automated drive control may be suspended even in situations where suspension of the automated drive control is avoidable. If the user cannot grasp the reason, further, the user does not know how the automated drive control can be recovered after the automated drive control is suspended, and thus suspension of the automated drive control is continued, which may be disadvantage to the user. If the user cannot grasp the reason for which the automated drive control cannot be executed, in addition, the user also cannot grasp the conditions on which the automated drive control will be recovered, which imposes a significant burden for the drive operation on the user.

Exemplary embodiments of the broad inventive principles described herein provide an automated drive assisting system, an automated drive assisting method, and a computer program that enable a vehicle to travel through automated drive control more appropriately by providing guidance on the reason for which the automated drive control cannot be executed in the case where the automated drive control cannot be executed.

Exemplary embodiments provide systems, methods, and programs that acquire a non-execution reason, for which automated drive control cannot be executed, in the case where the automated drive control cannot be executed during travel in an automated drive section in which the automated drive control for a vehicle is permitted. The systems, methods, and programs provide guidance on the acquired non-execution reason, and determine whether or not the non-execution reason is a reason that is avoidable by a drive operation by a driver of the vehicle. The systems, methods, and programs provide, in the case where it is determined that the non-execution reason is a reason that is avoidable by a drive operation by the driver, guidance on a drive operation for avoiding the reason.

With the automated drive assisting system, the automated drive assisting method, and the computer program configured as described above, guidance on a reason for which automated drive control cannot be executed is provided in the case where the automated drive control cannot be executed, and thus it is possible to avoid suspension of the automated drive control by a drive operation by a user, depending on the reason. In addition, the user can grasp under what conditions the automated drive control will be recovered. Thus, travel through the automated drive control can be recovered at an earlier timing even in the case where the automated drive control is suspended, and the timing at which travel through the automated drive control is recovered can be grasped beforehand. Thus, it is possible to reduce the burden for the drive operation on the user, and to enable the vehicle to appropriately travel through the automated drive control.

### BRIEF DESCRIPTION OF THE DRAWINGS

FIG. 1 is a block diagram illustrating the configuration of a navigation apparatus according to an embodiment.

FIG. 2 is a flowchart of a travel assist processing program according to the embodiment.

FIG. 3 is a flowchart of the travel assist processing program according to the embodiment.

FIG. 4 is a flowchart of the travel assist processing program according to the embodiment.

FIG. 5 illustrates reasons for which automated drive control cannot be executed and the types of the reasons.

FIG. 6 illustrates an example in which the automated drive control cannot be executed because of a reason that is avoidable by a drive operation by a driver of a vehicle.

FIG. 7 illustrates a guidance screen displayed on a liquid crystal display in the case where the automated drive control cannot be executed because of a reason that is avoidable by a drive operation by the driver of the vehicle.

FIG. 8 illustrates an example in which the automated drive control cannot be executed because of a reason that is caused in a specific section.

FIG. 9 illustrates a guidance screen displayed on the liquid crystal display in the case where the automated drive control cannot be executed because of a reason that is caused in a specific section.

FIG. 10 illustrates an example in which the automated drive control cannot be executed because of a reason that is not avoidable by a drive operation by the driver of the vehicle and that is caused in a non-specific section.

### DETAILED DESCRIPTION OF EXEMPLARY EMBODIMENTS

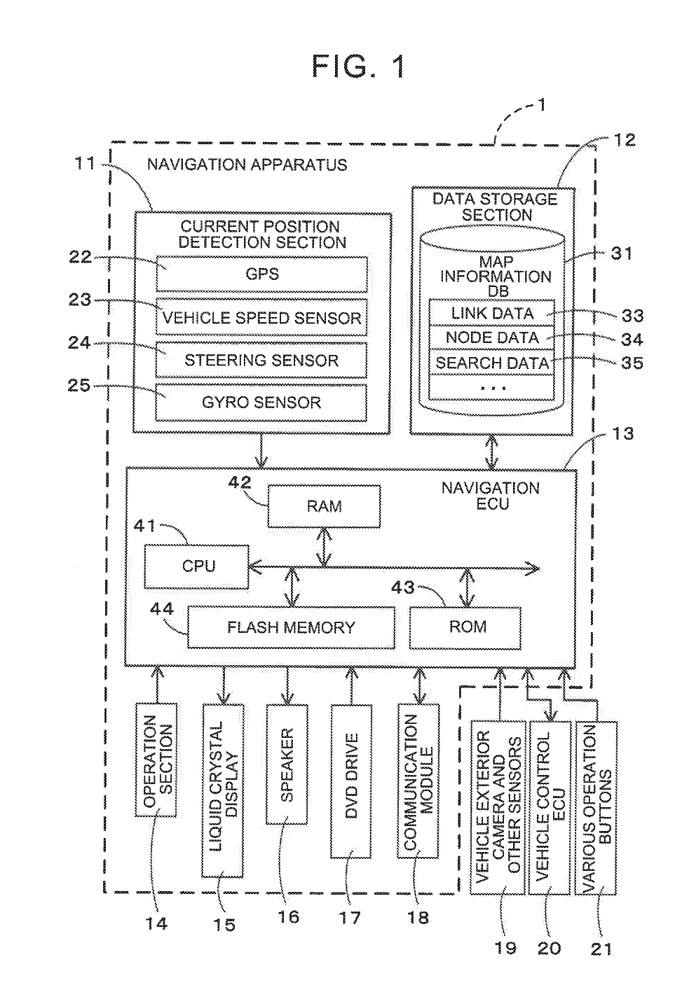

An automated drive assisting system, embodied as a navigation apparatus, according to an embodiment will be described in detail below with reference to the drawings. First, a schematic configuration of a navigation apparatus 1 according to the embodiment will be described with reference to FIG. 1. FIG. 1 is a block diagram illustrating the navigation apparatus 1 according to the embodiment.

As illustrated in FIG. 1, the navigation apparatus 1 according to the embodiment is composed of: a current position detection section 11 that detects the current position of the vehicle on which the navigation apparatus 1 is mounted; a data storage section 12 that stores various types of data; a navigation ECU 13 that performs various computation processing on the basis of input information; an operation section 14 that receives an operation from a user; a liquid crystal display 15 that displays, to the user, a map of an area around the vehicle, information on a route for guidance (an expected travel route for the vehicle) set in the navigation apparatus 1, and so forth; a speaker 16 that outputs audio route guidance; a DVD drive 17 that reads a DVD that serves as a storage medium; and a communication module 18 that communicates with an information center such as a probe center and a VICS (registered trademark: Vehicle Information and Communication System) center. In addition, the navigation apparatus 1 is connected to a vehicle exterior camera 19 and various sensors installed on the vehicle on which the navigation apparatus 1 is mounted via an in-vehicle network such as a CAN. Furthermore, the navigation apparatus 1 is connected to a vehicle control ECU 20 that performs various types of control for the vehicle on which the navigation apparatus 1 is mounted in a mutually communicable manner. The navigation apparatus 1 is also connected to various operation buttons 21 mounted on the vehicle such as an automated drive switch and an automated drive start button.

The constituent elements of the navigation apparatus 1 will be described below in order.

The current position detection section 11 is composed of a GPS 22, a vehicle speed sensor 23, a steering sensor 24, a gyro sensor 25, and so forth, and can detect the current position of the vehicle, the orientation, the travel speed of the vehicle, the current time, and so forth. In particular, the vehicle speed sensor 23 is a sensor that detects the travel distance of the vehicle and the vehicle speed, and generates pulses in accordance with rotation of drive wheels of the vehicle to output a pulse signal to the navigation ECU 13. The navigation ECU 13 counts the generated pulses to calculate the rotational speed of the drive wheels and the travel distance. It is not necessary that the navigation apparatus 1 should include all of the four sensors, and the navigation apparatus 1 may be configured to include only one or a plurality of such sensors.

The data storage section 12 includes: a hard disk (not illustrated) that serves as an external storage device and a storage medium; and a recording head (not illustrated) that serves as a driver that reads a map information DB 31, a predetermined program, and so forth stored in the hard disk and writes predetermined data into the hard disk. (As used herein the term “storage medium” is not intended to encompass transitory signals.) The data storage section 12 may be constituted of a flash memory, a memory card, or an optical disk such as a CD or a DVD in place of the hard disk. The map information DB 31 may be stored in an external server to be acquired by the navigation apparatus 1 through communication.

The map information DB 31 is storage means for storing link data 33 on roads (links), node data 34 on node points, search data 35 for use in processing for searching for a route and changing the route, facility data on facilities, map display data for displaying a map, intersection data on intersections, retrieval data for retrieving a location, and so forth, for example.

The stored link data 33 include: for links composing a road, data representing the width of the road to which the link belongs, gradient, cant, bank, road surface state, merging section, road structure, number of lanes of the road, location at which the number of lanes is reduced, location at which the width is reduced, a railroad crossing, and so forth; for corners, data representing the radius of curvature, an intersection, a T junction, an entrance to and an exit from the corner, and so forth; for road attributes, data representing a descending road, an ascending road, and so forth; and for road types, data representing a general road such as a national road, a prefectural road, and a narrow street, and a toll road such as a national express highway, an urban expressway, a road exclusively for automobiles, an ordinary toll road, and a toll bridge.

The stored node data 34 include: the coordinate (position) of a branch point (including an intersection, a T junction, etc.) of actual roads and a node point set every predetermined distance in accordance with the radius of curvature etc. on the roads;

the node attribute representing whether the node is a node corresponding to an intersection or the like; a connected link number list which is a list of the link numbers of links connected to the node; an adjacent node number list which is a list of the node numbers of nodes that are adjacent to the node via a link; and data on the height (altitude) of each node point.

The stored search data 35 include various types of data for use in route search processing for searching for a route from a departure location (e.g. the current position of the vehicle) to a set destination location. Specifically, the stored search data 35 include cost calculation data used to calculate a search cost such as a cost (hereinafter referred to as an “intersection cost”) obtained by quantifying the degree of suitability of an intersection for a route and a cost (hereinafter referred to as a “link cost”) obtained by quantifying the degree of suitability of a link composing a road for a route.

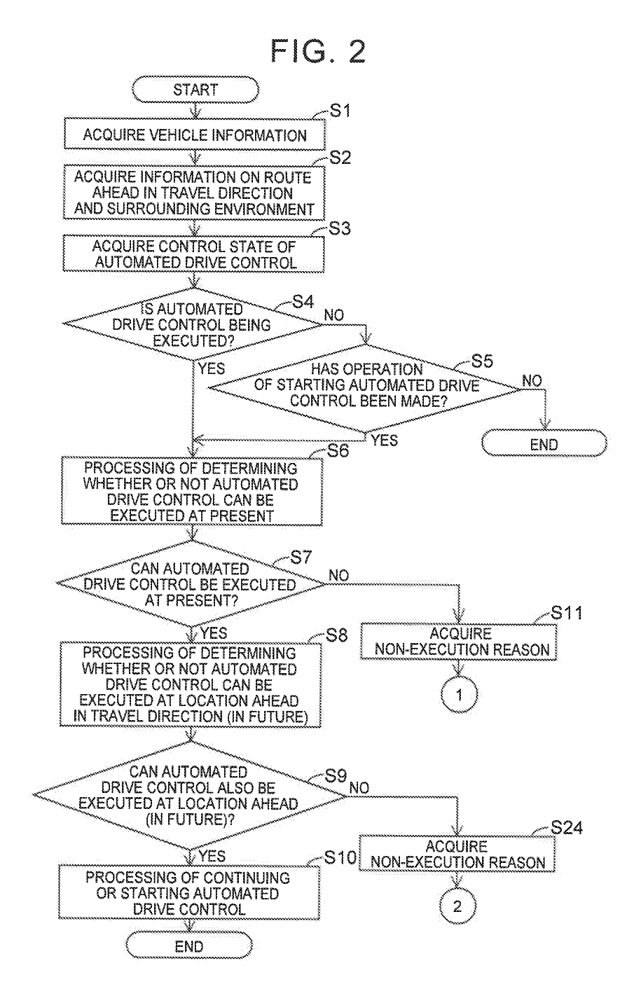

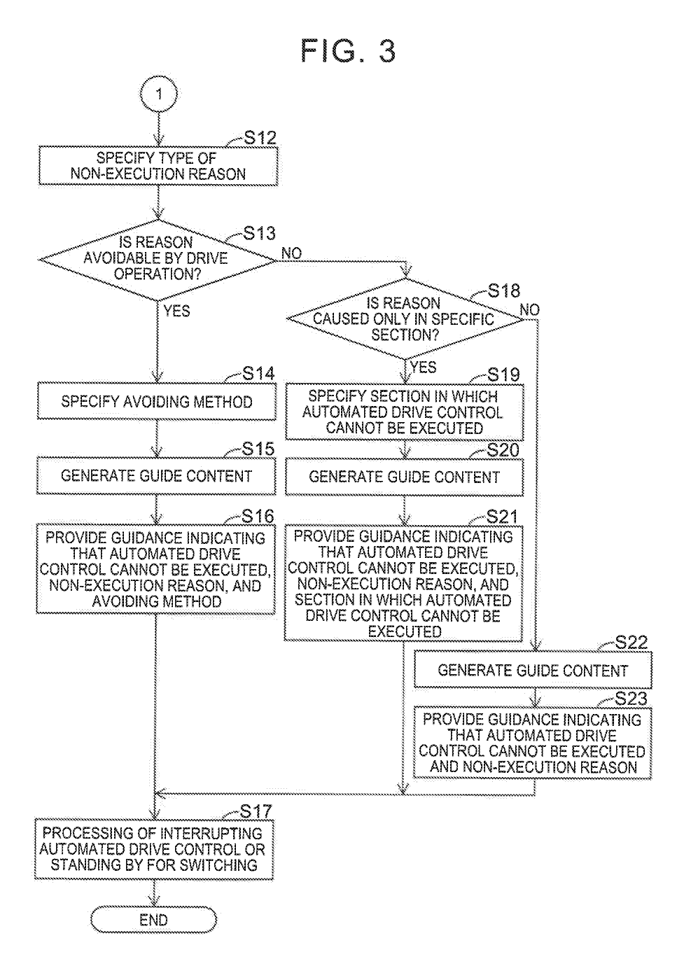

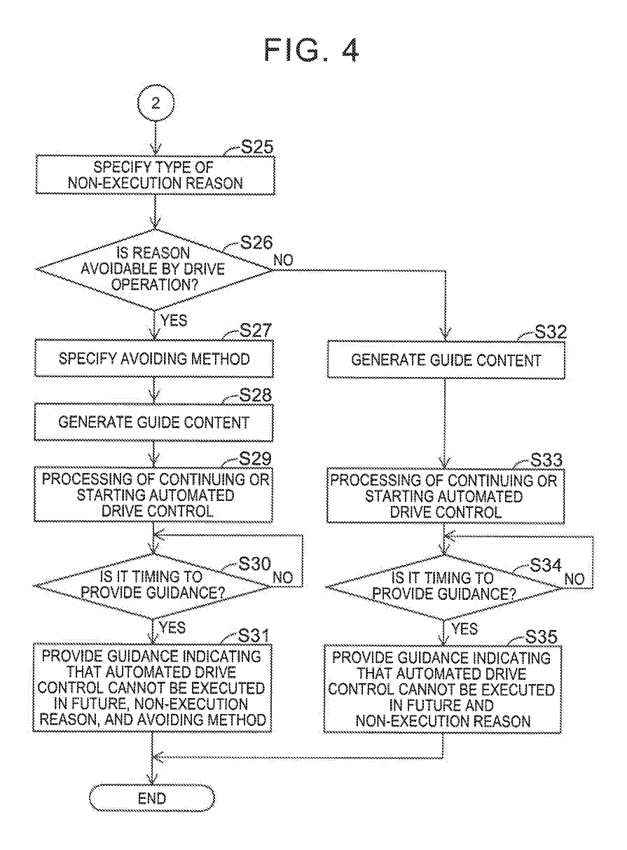

The navigation ECU (electronic control unit) 13 is an electronic control unit that controls the entire navigation apparatus 1, and includes a CPU 41 that serves as a computation device and a control device, and internal storage devices such as a RAM 42 that is used as a working memory when the CPU 41 performs various types of computation processing and that stores route data etc. when a route is found, a ROM 43 that stores a control program, a travel assist processing program (see FIGS. 2 to 4) to be discussed later, and so forth, and a flash memory 44 that stores a program read from the ROM 43. The navigation ECU 13 constitutes various means as processing algorithms. For example, non-execution reason acquisition means acquires a non-execution reason, for which automated drive control cannot be executed, in the case where the automated drive control cannot be executed during travel in an automated drive section in which the automated drive control for the vehicle is permitted. Non-execution reason guide means provides guidance on the non-execution reason acquired by the non-execution reason acquisition means.

The operation section 14 is operated to input a departure location at which travel is started and a destination location at which travel is ended, and composed of a plurality of operation switches (not illustrated) such as various keys and buttons. The navigation ECU 13 performs control so as to execute various corresponding operation on the basis of a switch signal output in response to a depression of a switch or the like. The operation section 14 may be composed of a touch panel provided on the front surface of the liquid crystal display 15. The operation section 14 may be composed of a microphone and a speech recognition device.

The liquid crystal display 15 displays a map image that includes roads, traffic information, operational guidance, an operation menu, key guidance, guidance information on a travel along a route for guidance (expected travel route), news, weather forecasts, the time, mails, television programs, and so forth. In the embodiment, in addition, the liquid crystal display 15 also indicates that the automated drive control cannot be executed, the reason for which the automated drive control cannot be executed, and the section in which the automated drive control cannot be executed during travel through the automated drive control or in the case where switching has been made from travel through manual drive to travel through the automated drive control and it is determined that the automated drive control cannot be executed at present or in the future. An HUD or an HMD may be used in place of the liquid crystal display 15.

Examples of the travel mode of the vehicle include travel through the automated drive control in which the vehicle travels automatically along a route set in advance with no reliance on a drive operation by the user, besides manual drive travel in which the vehicle travels on the basis of a drive operation by the user. In the automated drive control, for example, the current position of the vehicle, the lane in which the vehicle travels, and the positions of other vehicles around the vehicle are detected at all times, and vehicle control for a steering unit, a drive source, a brake unit, and so forth is performed automatically such that the vehicle travels along a route set in advance by the vehicle control ECU 20. The details of the automated drive control are already known in the art, and thus are not described herein. The automated drive control may be performed for all road sections. In the following description, however, a highway provided with a gate at the boundary (whether attended or unattended, charged or free) with another connected road is set as an automated drive section in which the vehicle is subjected to the automated drive control, and the vehicle is basically subjected to the automated drive control only while the vehicle travels in the automated drive section. It should be noted, however, that other sections may be set as the automated drive section. For example, national express highways, urban expressways, roads exclusively for automobiles, toll roads, and general roads may be set as the automated drive section. The automated drive control is not always performed in the case where the vehicle travels in the automated drive section, but is performed only in situations where the user selects performing the automated drive control and it is determined that the vehicle can travel through the automated drive control as discussed later. That is, the automated drive section is a section in which the automated drive control is permitted for the vehicle in addition to the manual drive.

Although travel through the automated drive control is advantageous in that a burden related to drive on the user can be reduced, travel through the automated drive control may be difficult in some situations, depending on the road conditions and the surrounding environment. Examples of such situations include a case where the vehicle travels in a section in which the vehicle is required to make a lane change within a predetermined distance and a case where the vehicle travels in a section in which a partition line has disappeared or faded to such a degree that the partition line cannot be recognized using a camera. Thus, in the navigation apparatus 1 according to the embodiment, it is determined whether or not the automated drive control can be executed in consideration of information acquired from the vehicle exterior camera 19 or an external server in the case where the vehicle travels in the automated drive section, and the vehicle control ECU 20 is instructed to suspend the automated drive control for the vehicle and travel through the manual drive in the case where it is determined that the automated drive control cannot be executed. Furthermore, the navigation apparatus 1 provides not only guidance indicating that the automated drive control cannot be executed, but also guidance on the reason for which the automated drive control cannot be executed and the section in which the automated drive control cannot be executed.

The speaker 16 outputs audio guidance on travel along a route for guidance and guidance on traffic information on the basis of an instruction from the navigation ECU 13. In the embodiment, in addition, the speaker 16 also outputs not only audio guidance indicating that the automated drive control cannot be executed, but also audio guidance on the reason for which the automated drive control cannot be executed and the section in which the automated drive control cannot be executed, during travel through the automated drive control or in the case where switching has been made from travel through manual drive to travel through the automated drive control and it is determined that the automated drive control cannot be executed at present or in the future.

The DVD drive 17 is a drive that can read data stored in a storage medium such as a DVD and a CD. Music and video is reproduced, the map information DB 31 is updated, etc. on the basis of the read data. A card slot for reading and writing of a memory card may be provided in place of the DVD drive 17.

The communication module 18 is a communication device that receives traffic information, probe information, weather information, etc. transmitted from a traffic information center such as the VICS center or a probe center, for example, and may be a cellular phone or a DCM, for example. The communication module 18 may also include a vehicle-to-vehicle communication device that performs vehicle-to-vehicle communication and a road-to-vehicle communication device that performs communication with a roadside unit.

The vehicle exterior camera 19 is constituted of a camera that uses a solid-state imaging element such as a CCD, for example, and is attached above the front bumper of the vehicle and installed with its optical axis directed a predetermined angle downward with respect to the horizontal direction. The vehicle exterior camera 19 captures a scene ahead in the travel direction of the vehicle in the case where the vehicle travels in the automated drive section. In addition, the vehicle control ECU 20 performs image processing on the captured image to detect a partition line drawn on the road on which the vehicle travels, other vehicles around the vehicle, and so forth, and performs the automated drive control for the vehicle on the basis of the detection results. The vehicle exterior camera 19 may be disposed on the rear side or at a side, rather than on the front side, of the vehicle. A sensor such as a millimeter wave radar, vehicle-to-vehicle communication, or road-to-vehicle communication may be used, in place of the camera, as means for detecting other vehicles. An illuminance sensor or a rainfall sensor may be installed as means for detecting the weather in the surrounding area.

The vehicle control ECU 20 is an electronic control unit that controls the vehicle on which the navigation apparatus 1 is mounted. In addition, the vehicle control ECU 20 is connected to various drive sections of the vehicle such as a steering unit, a brake unit, and an accelerator. In the embodiment, the vehicle control ECU 20 executes the automated drive control for the vehicle by controlling the drive sections particularly in the case where the vehicle travels in the automated drive section. In addition, the navigation ECU 13 transmits an instruction signal related to the automated drive control to the vehicle control ECU 20 via a CAN when an expected travel route (route for guidance) for the vehicle is decided. The vehicle control ECU 20 executes the automated drive control after the start of travel in accordance with the received instruction signal. The content of the instruction signal includes information for specifying the expected travel route (route for guidance) and information for setting the control content (such as straight travel, a lane change to the right, and a lane merge, for example) of the automated drive control to be performed on the vehicle in the automated drive section which is included in the expected travel route.

Subsequently, a travel assist processing program executed by the CPU 41 of the navigation apparatus 1 according to the embodiment configured as described above will be described with reference to FIG. 2. FIG. 2 is a flowchart of the travel assist processing program according to the embodiment. The travel assist processing program is a program executed, after the ACC of the vehicle is turned on, to determine whether or not the vehicle which travels in the automated drive section can travel through the automated drive control, and to provide guidance on the determination results. The program illustrated in the flowcharts of FIGS. 2 to 4 described below is stored in the RAM 42 or the ROM 43 of the navigation apparatus 1, and executed by the CPU 41.

In the travel assist processing program, first, in step (hereinafter abbreviated as “S”) 1, the CPU 41 acquires vehicle information on the vehicle. Specifically, the CPU 41 acquires the current position of the vehicle which is detected by the current position detection section 11 and the current vehicle speed which is detected by the vehicle speed sensor 23. It is desirable that the current position of the vehicle should be specified precisely using a high-precision location technique.

Next, in S2, the CPU 41 acquires information on the route ahead in the travel direction of the vehicle and the surrounding environment by reading information from the map information DB 31, acquiring the result of the detection performed by the vehicle exterior camera 19 and the various other sensors, or communicating with an external server such as the VICS center or a probe center. Examples of the information on the route ahead in the travel direction of the vehicle include route information (such as the presence or absence of right and left turns, lane changes, and lane merges), the road shape, the presence or absence of a traffic jam and an accident, and the state of fading of partition lines for the route within 1 km from the current position of the vehicle along the expected travel route. Meanwhile, examples of the surrounding environment include the position and the size of obstructions (such as other vehicles) positioned around the vehicle and the weather.

Subsequently, in S3, the CPU 41 communicates with the vehicle control ECU 20 via a CAN to acquire the control state of the automated drive control, specifically whether or not the automated drive control is being executed in the vehicle at present.

Subsequently, in S4, the CPU 41 determines, on the basis of the control state acquired in S3, whether or not the automated drive control is being executed in the vehicle at present. In the embodiment, the automated drive control is executed in the case where the vehicle travels in the automated drive section set in advance such as a highway, and only in situations where the user selects performing the automated drive control and it is determined that the vehicle can travel through the automated drive control as discussed later.

In the case where it is determined that the automated drive control is being executed in the vehicle (S4: YES), the processing proceeds to S6. In the case where it is determined that the automated drive control is not being executed in the vehicle (S4: NO), in contrast, the processing proceeds to S5.

In S5, the CPU 41 determines whether or not the vehicle is traveling in the automated drive section and an operation for switching the travel mode of the vehicle from the manual drive to travel through the automated drive control has been made. Specifically, it is determined whether or not the automated drive start button has been turned on with the vehicle traveling in the automated drive section. The automated drive start button is disposed in an instrument panel or the like, and switched on and off each time the user depresses the automated drive start button. When the automated drive start button is turned on with the vehicle traveling in the automated drive section, the automated drive control is started. When the automated drive start button is turned off during execution of the automated drive control, meanwhile, the automated drive control is ended even during travel in the automated drive section, and switching is made to the manual drive.

In the case where it is determined that the vehicle is traveling in the automated drive section and an operation for switching the travel mode of the vehicle from the manual drive to travel through the automated drive control has been made (S5: YES), the processing proceeds to S6. In the case where it is determined that the vehicle is traveling outside the automated drive section or an operation for switching the travel mode of the vehicle from the manual drive to travel through the automated drive control has not been made (S5: NO), in contrast, the travel assist processing program is ended without switching the travel mode of the vehicle to the automated drive control.

In S6, the CPU 41 executes processing of determining, on the basis of the various types of information acquired in S1 and S2, whether or not the vehicle is currently in a situation where the automated drive control can be executed. Examples of the situation where the automated drive control cannot be executed include: a situation where the vehicle is in unstable behavior; a situation where travel of the vehicle is restricted by a regulation or the like; a situation where a difficult vehicle operation is required (e.g. a situation where it is necessary to make a predetermined amount or more of a brake operation or a steering operation within a predetermined time); a situation where information that is necessary to execute the automated drive control cannot be obtained because of the poor road surface conditions or visibility; and a situation where the automated drive control cannot be executed physically because of a system malfunction or the like. More specifically, it is determined that the vehicle is in a situation where the automated drive control cannot be executed in the case where one of the following conditions (1) to (8) is met.
(1) The vehicle speed is a threshold (e.g. 100 km/h) or more.
(2) The vehicle is traveling in a section that requires the vehicle to make a lane change, and a lane change cannot be made through the automated drive control. For example, the vehicle is required to make a lane change within a short section (e.g. 500 m or less), a large number of other vehicles are traveling in the lane to which a lane change is to be made, or the like.
(3) A partition line (such as a roadway center line, a lane boundary line, and a roadway outer line) of the lane in which the vehicle travels (not all lanes) has disappeared or faded to such a degree that the partition line cannot be recognized using a camera.
(4) The vehicle travels on a road in a specific shape that does not allow execution of the automated drive control (e.g. a curve with a predetermined curvature or more, or a slope at a predetermined inclination angle or more).
(5) The vehicle travels in an accident or road work section.
(6) Partition lines (such as a roadway center line, a lane boundary line, and a roadway outer line) of all lanes including the lane in which the vehicle travels have disappeared or faded to such a degree that the partition lines cannot be recognized using a camera.
(7) The vehicle travels in a weather that makes detection by a camera or a sensor difficult or a weather that makes vehicle control difficult (e.g. heavy rain, thick fog, snow accumulation, and a frozen road surface).
(8) The system related to the automated drive control is out of order.

Next, in S7, the CPU 41 determines, on the basis of the result of the process in S6, whether or not the vehicle is currently in a situation where the automated drive control can be executed.

In the case where it is determined that the vehicle is currently in a situation where the automated drive control can be executed (S7: YES), that is, none of the conditions (1) to (8) is met for the vehicle at present, the processing proceeds to S8.

In contrast, in the case where it is determined that the vehicle is not currently in a situation where the automated drive control can be executed (S7: NO), that is, any of the conditions (1) to (8) is met for the vehicle at present, the processing proceeds to S11.

In S8, the CPU 41 executes processing of determining, on the basis of the various types of information acquired in S1 and S2, whether or not the vehicle will be in a situation where the automated drive control can be executed while the vehicle travels within a predetermined distance ahead in the travel direction (i.e. in the future rather than at present). In some cases, it is predicted that any of the conditions (1) to (8) will be met while the vehicle travels the predetermined distance although none of the conditions (1) to (8) is met at present. The predetermined distance may be a fixed distance (e.g. 1 km), or may be varied in accordance with the vehicle speed or the road type. A predetermined time (e.g. 1 minute) may be used instead of the predetermined distance.

Next, in S9, the CPU 41 determines, on the basis of the result of the processing in S8, whether or not the vehicle will always be in a situation where the automated drive control can be executed while the vehicle travels within the predetermined distance ahead in the travel direction. Specifically, it is predicted whether or not any of the conditions (1) to (8) will be met while the vehicle travels within the predetermined distance ahead in the travel direction.

In the case where it is determined that the vehicle will always be in a situation where the automated drive control can be executed while the vehicle travels within the predetermined distance ahead in the travel direction (S9: YES), that is, it is predicted that none of the conditions (1) to (8) will be met while the vehicle travels within the predetermined distance ahead in the travel direction, the processing proceeds to S10.

In contrast, in the case where it is determined that the vehicle will fall into a situation where the automated drive control cannot be executed while the vehicle travels within the predetermined distance ahead in the travel direction (S9: NO), that is, it is predicted that any of the conditions (1) to (8) will be met while the vehicle travels within the predetermined distance ahead in the travel direction, the processing proceeds to S10.

In S10, the CPU 41 executes processing of continuing or starting the automated drive control. In the case where it is determined in S4 that the automated drive control is executed (S4: YES), no particular instruction is provided to the vehicle control ECU 20 in S10. As a result, the automated drive control which is currently performed in the vehicle continues to be executed. In the case where it is determined in S5 that an operation for starting the automated drive control has been performed (S5: YES), meanwhile, the CPU 41 transmits an instruction signal to the vehicle control ECU 20 via a CAN to switch the travel mode of the vehicle from the manual drive based on a drive operation by the user to travel through the automated drive control in S10. As a result, the vehicle control ECU 20 which has received the instruction signal starts processing related to the automated drive control, and the vehicle starts travel through the automated drive control. After that, the travel assist processing program is ended.

In S11 which is executed in the case where it is determined in S7 that the vehicle is currently in a situation where the automated drive control cannot be executed (S7: NO), meanwhile, the CPU 41 acquires a non-execution reason which is a reason for which the automated drive control cannot be executed. In the embodiment, the non-execution reason corresponds to the one of the conditions (1) to (8) which is determined to be met in S7. In the case where a plurality of conditions are determined to be met in S7, a plurality of relevant non-execution reasons are acquired.

Next, in S12, the CPU 41 specifies the type of the non-execution reason acquired in S11. In the embodiment, the non-execution reason is basically classified into one of the following three types.
(A) Reasons that are avoidable by a drive operation by the driver of the vehicle.
(B) Reasons that are caused only in a specific section.
(C) Others (reasons that are not avoidable by a drive operation by the driver and that are caused in any section or permanently).

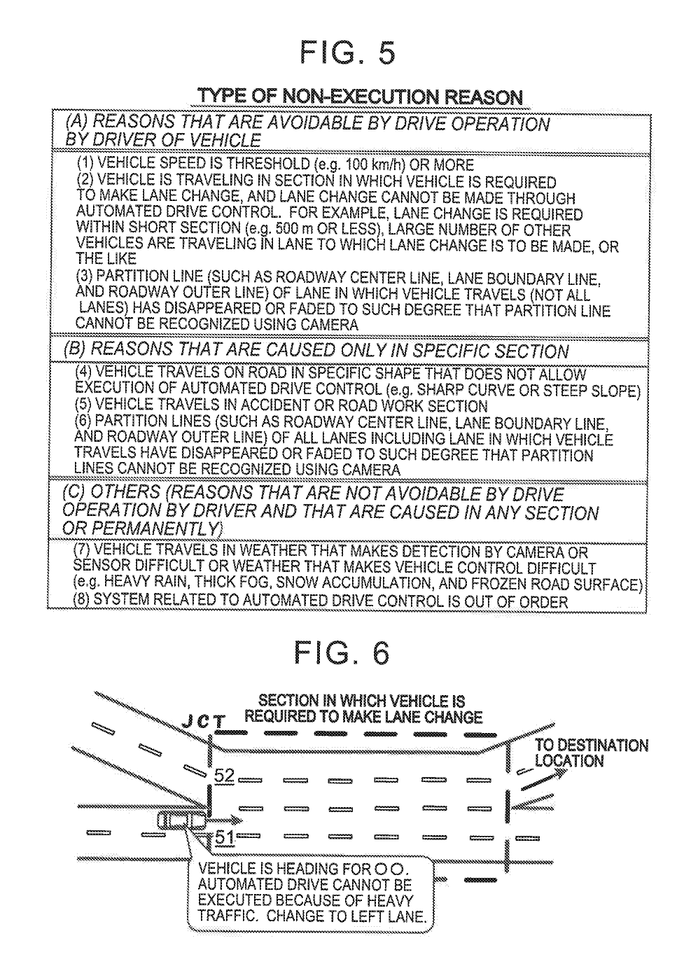

Among the non-execution reasons (1) to (8) described above, as indicated in FIG. 5, the non-execution reasons (1) to (3) are classified into “(A) reasons that are avoidable by a drive operation by the driver of the vehicle”; the non-execution reasons (4) to (6) are classified into “(B) reasons that are caused only in a specific section”; and the non-execution reasons (7) and (8) are classified into “(C) other reasons.” Thus, in S12, the CPU 41 specifies, on the basis of the correlation indicated in FIG. 5, which of the types (A) to (C) the non-execution reason acquired in S11 is classified into. In the case where a plurality of non-execution reasons are acquired in S11, one of the types is specified for each of the plurality of acquired non-execution reasons.

Subsequently, in S13, the CPU 41 determines whether or not the type of the non-execution reason specified in S12 is one of the “(A) reasons that are avoidable by a drive operation by the driver of the vehicle.”

In the case where it is determined that the type of the non-execution reason specified in S12 is one of the “(A) reasons that are avoidable by a drive operation by the driver of the vehicle” (S13: YES), the processing proceeds to S14. In the case where it is determined that the type of the non-execution reason specified in S12 is not one of the “(A) reasons that are avoidable by a drive operation by the driver of the vehicle” (S13: NO), in contrast, the processing proceeds to S18.

In S14, the CPU 41 specifies a drive operation method for avoiding the non-execution reason. For example, in the case where the non-execution reason is that the vehicle speed is a threshold (e.g. 100 km/h) or more, the drive operation for avoiding the non-execution reason is determined as an operation of reducing the vehicle speed. In the case where the non-execution reason is that the vehicle is traveling in a section that requires the vehicle to make a lane change and a lane change cannot be made through the automated drive control in the section, meanwhile, the drive operation for avoiding the non-execution reason is determined as an operation of making a lane change along the route for guidance. In the case where the non-execution reason is that a partition line (such as a roadway center line, a lane boundary line, and a roadway outer line) of the lane in which the vehicle travels (not all lanes) has disappeared or faded to such a degree that the partition line cannot be recognized using a camera, further, the drive operation for avoiding the non-execution reason is determined as an operation of making a lane change to a lane, a partition line of which can be recognized.

Next, in S15, the CPU 41 generates the content of guidance to be provided to the user. Specifically, the guide content is generated so as to indicate that the automated drive control cannot be executed, the non-execution reason acquired in S11, and the drive operation method for avoiding the non-execution reason specified in S14. For example, in the case where the non-execution reason is that the vehicle speed is a threshold (e.g. 100 km/h) or more, audio guidance saying “Automated drive cannot be executed because of the high travel speed. Reduce the speed to ◯◯ km/h.” is generated. In the case where the non-execution reason is that the vehicle is traveling in a section that requires the vehicle to make a lane change and a lane change cannot be made through the automated drive control in the section, audio guidance saying “The vehicle is heading for ◯◯. Automated drive cannot be executed because of the heavy traffic. Change to the right (left) lane.” is generated. An image for guidance that instructs a lane change is also generated. In the case where the non-execution reason is that a partition line (such as a roadway center line, a lane boundary line, and a roadway outer line) of the lane in which the vehicle travels (not all lanes) has disappeared or faded to such a degree that the partition line cannot be recognized using a camera, an audio content saying “Automated drive cannot be executed because of the poor lane condition. Change to the right (left) lane.” is generated. An image for guidance that instructs a lane change is also generated.

After that, in S16, the CPU 41 outputs the guide content generated in S15 from the liquid crystal display 15 and the speaker 16 to provide guidance indicating that the automated drive control cannot be executed, the non-execution reason acquired in S11, and the drive operation method for avoiding the non-execution reason specified in S14.

Guide processing performed in S16 will be described using a specific example.

In the case where it is necessary for the vehicle to change to a different road 52 at a JCT, at which a main lane 51 and the different road 52 are connected to each other as illustrated in FIG. 6, in order to reach a destination location, for example, it is necessary to make a lane change to the left lane. If it is determined that a lane change cannot be made through the automated drive control because the road 52 is crowded, a section in which the vehicle is required to make a lane change is too short, or the like, audio guidance saying “The vehicle is heading for ◯◯. Automated drive cannot be executed because of the heavy traffic. Change to the left lane.” is output from the speaker 16. In addition, the screen of the liquid crystal display 15 is divided into left and right halves as illustrated in FIG. 17, and an enlarged guide screen 56 that indicates a lane change to the left lane is newly displayed in addition to a normal travel guide screen 55 that illustrates a map image of an area around the vehicle and the route for guidance. As a result of providing guidance as described above, the user can understand that it is necessary to make a lane change to the left lane in order to travel along the route for guidance, but that the automated drive control is temporarily interrupted because a lane change cannot be made through the automated drive control. The user can further understand that travel through the automated drive control can be recovered again when a lane change to the left is made through the manual drive.

After that, in S17, the CPU 41 executes processing of interrupting the automated drive control or standing by for switching. Specifically, in the case where it is determined in S4 that the automated drive control is executed (S4: YES), an instruction signal is transmitted to the vehicle control ECU 20 via a CAN to temporarily interrupt the automated drive control. As a result, the automated drive control for the vehicle is temporarily interrupted, and switching is made to the manual drive. Switching to the manual drive may be made automatically, or guidance that prompts the user to make a changeover to the manual drive may be provided and switching to the manual drive may be made on condition that the user operates the steering unit, the accelerator, the brake unit, or the like by a predetermined amount or more. Interruption of the automated drive control is basically continued until the non-execution reason is resolved. After the non-execution reason is resolved (e.g. after the non-execution reason is avoided by a drive operation by the driver), the automated drive control may be recovered automatically, or the manual drive may be performed until the user makes an operation of starting the automated drive control.

In the case where it is determined in S5 that an operation for starting the automated drive control has been performed (S5: YES), meanwhile, the CPU 41 transmits an instruction signal to the vehicle control ECU 20 via a CAN to temporarily stand by for switching from the manual drive to the automated drive control in S10. As a result, the vehicle continues to travel through the manual drive. Standing by for switching is basically continued until the non-execution reason is resolved. After the non-execution reason is resolved (e.g. after the non-execution reason is avoided by a drive operation by the driver), switching may be made to the automated drive control automatically, or the manual drive may be performed until the user makes an operation of starting the automated drive control again.

In S18, meanwhile, the CPU 41 determines whether or not the type of the non-execution reason specified in S12 is one of the “(B) reasons that are caused only in a specific section.”

In the case where it is determined that the type of the non-execution reason specified in S12 is one of the “(B) reasons that are caused only in a specific section” (S18: YES), the processing proceeds to S19. In the case where it is determined that the type of the non-execution reason specified in S12 is one of the “(C) others,” (S18: NO), in contrast, the processing proceeds to S22.

In S19, the CPU 41 specifies a section in which the non-execution reason is caused, that is, a section in which the automated drive control cannot be executed. For example, in the case where the non-execution reason is travel on a road in a specific shape that does not allow execution of the automated drive control (e.g. a sharp curve or a steep slope), the section in which the automated drive control cannot be executed is specified as the road section in the specific shape. In the case where the non-execution reason is travel in an accident or road work section, the section in which the automated drive control cannot be executed is specified as the accident or road work section. In the case where the non-execution reason is that partition lines (such as a roadway center line, a lane boundary line, and a roadway outer line) of all lanes including the lane in which the vehicle travels have disappeared or faded to such a degree that the partition lines cannot be recognized using a camera, the section in which the automated drive control cannot be executed is specified as the section before the point after which the partition lines can be recognized.

Next, in S20, the CPU 41 generates the content of guidance to be provided to the user. Specifically, the guide content is generated so as to indicate that the automated drive control cannot be executed, the non-execution reason acquired in S11, and the section in which the automated drive control cannot be executed specified in S19. For example, an audio content saying “Automated drive cannot be executed because ◯◯is located ahead. Execute automated drive again after passing by ◯◯” is generated. An image for guidance that indicates the section in which the automated drive control cannot be executed is also generated.

After that, in S21, the CPU 41 outputs the guide content generated in S20 from the liquid crystal display 15 and the speaker 16 to provide guidance indicating that the automated drive control cannot be executed, the non-execution reason acquired in S11, and the section in which the automated drive control cannot be executed specified in S19.

Guide processing performed in S21 will be described using a specific example.

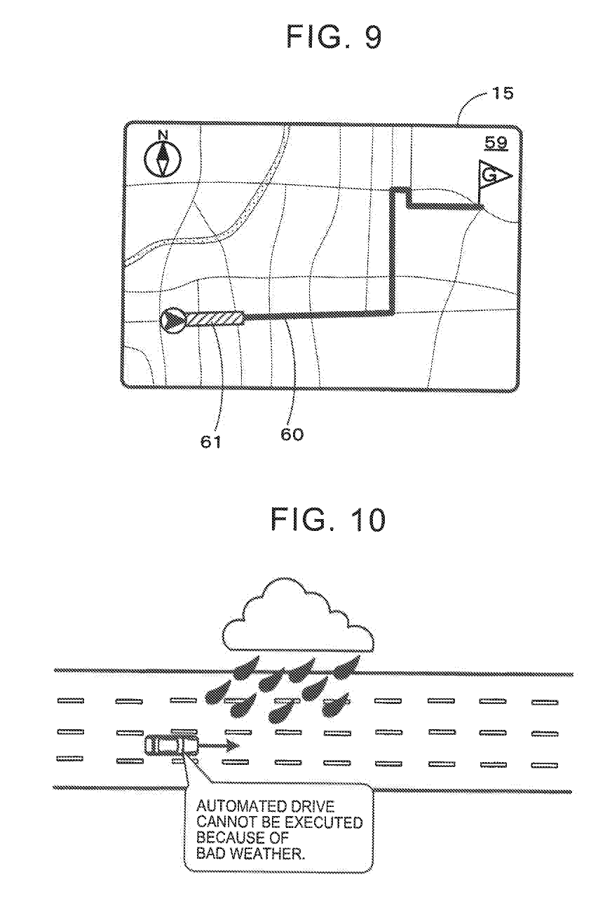

For example, in the case where partition lines 58 of all lanes including a lane 57 in which the vehicle travels have disappeared or faded to such a degree that the partition lines 58 cannot be recognized using a camera as illustrated in FIG. 8, the partition lines 58 cannot be recognized using a camera, and the vehicle cannot travel appropriately along the lane 57. Since the reason is not avoidable even if a lane change is made, in addition, travel through the automated drive control cannot be executed in the section in which the partition lines 58 have faded (or disappeared). Thus, audio guidance saying “Automated drive cannot be executed because there is a section in which partition lines have faded ahead. Execute automated drive again after passing through the section” is output from the speaker 16. As illustrated in FIG. 9, in addition, the liquid crystal display 15 newly displays an all-route guide screen 59 that indicates the route for guidance from the current position of the vehicle to the destination location. On the all-route guide screen 59, a route for guidance 60 is indicated, and a section 61 in which the automated drive control cannot be executed (section in which the partition lines 58 have faded (or disappeared)), which is a part of the route for guidance 60, is indicated so as to be distinguishable from the other sections. For example, the display color or the line thickness may be varied for the section 61. As a result of providing guidance as described above, the user can understand that the automated drive control is temporarily interrupted since the partition lines of the road on which the vehicle travels have faded. The user can further understand that travel through the automated drive control can be recovered again when the vehicle passes through the section on which guidance has been provided.

After that, in S17, the CPU 41 executes processing of interrupting the automated drive control or standing by for switching as described above. After the non-execution reason is resolved (i.e. after passing through the section in which the automated drive control cannot be executed), the automated drive control may be recovered automatically, switching may be made to the automated drive control, or the manual drive may be performed until the user makes an operation of starting the automated drive control.

In S22, meanwhile, the CPU 41 generates the content of guidance to be provided to the user. Specifically, the guide content is generated so as to indicate that the automated drive control cannot be executed and the non-execution reason acquired in S11. For example, an audio content saying “Automated drive cannot be executed because of ◯◯” is generated.

After that, in S23, the CPU 41 outputs the guide content generated in S22 from the liquid crystal display 15 and the speaker 16 to provide guidance indicating that the automated drive control cannot be executed and the non-execution reason acquired in S11.

Guide processing performed in S23 will be described using a specific example.

For example, as illustrated in FIG. 10, in the case where the heavy rain makes camera or sensor detection or vehicle control difficult, the vehicle cannot travel appropriately through the automated drive control. In addition, such difficulty is not avoidable even if a lane change is made, and thus travel through the automated drive control cannot be executed before the weather turns good. Moreover, the timing at which the automated drive control can be recovered cannot be specified. Thus, only audio guidance saying “Automated drive cannot be executed because of the bad weather.” is output from the speaker 16. As a result of providing guidance as described above, the user can understand that the automated drive control cannot be executed for a while.

After that, in S17, the CPU 41 executes processing of interrupting the automated drive control or standing by for switching as described above. After the non-execution reason is resolved (e.g. after the weather turns good), the automated drive control may be recovered automatically, switching may be made to the automated drive control, or the manual drive may be performed until the user makes an operation of starting the automated drive control.

In S24 which is executed in the case where it is determined in S9 that the vehicle will fall into a situation where the automated drive control cannot be executed while the vehicle travels within the predetermined distance ahead in the travel direction (S9: NO), meanwhile, the CPU 41 acquires a non-execution reason which is a reason for which it is predicted that the automated drive control cannot be executed in the future. In the embodiment, the non-execution reason corresponds to the one of the conditions (1) to (8) which is determined to be met in S9. In the case where a plurality of conditions are determined to be met in S9, a plurality of relevant non-execution reasons are acquired.

Next, in S25, the CPU 41 specifies the type of the non-execution reason acquired in S24. In the embodiment, as discussed above, the non-execution reason is basically classified into one of (A) to (C) described above (FIG. 5).

Subsequently, in S26, the CPU 41 determines whether or not the type of the non-execution reason specified in S25 is one of the “(A) reasons that are avoidable by a drive operation by the driver of the vehicle.”

In the case where it is determined that the type of the non-execution reason specified in S25 is one of the “(A) reasons that are avoidable by a drive operation by the driver of the vehicle” (S26: YES), the processing proceeds to S27. In the case where it is determined that the type of the non-execution reason specified in S25 is not one of the “(A) reasons that are avoidable by a drive operation by the driver of the vehicle” (S26: NO), in contrast, the processing proceeds to S32.

In S27, the CPU 41 specifies a drive operation method for avoiding the non-execution reason. For example, in the case where the non-execution reason is that it is predicted that the vehicle speed will be a threshold (e.g. 100 km/h) or more, the drive operation for avoiding the non-execution reason is determined as an operation of not increasing the vehicle speed. In the case where the non-execution reason is that the vehicle will enter a section that requires the vehicle to make a lane change and it is predicted that a lane change cannot be made through the automated drive control in the section, meanwhile, the drive operation for avoiding the non-execution reason is determined as an operation of making a lane change along the route for guidance. In the case where the non-execution reason is that it is predicted that the vehicle will enter a section in which a partition line (such as a roadway center line, a lane boundary line, and a roadway outer line) of the lane in which the vehicle travels (not all lanes) has disappeared or faded to such a degree that the partition line cannot be recognized using a camera, further, the drive operation for avoiding the non-execution reason is determined as an operation of making a lane change to a lane, a partition line of which can be recognized.

Next, in S28, the CPU 41 generates the content of guidance to be provided to the user. Specifically, the guide content is generated so as to indicate that the automated drive control cannot be executed in the future, the non-execution reason acquired in S24, and the drive operation method for avoiding the non-execution reason specified in S27. For example, in the case where the non-execution reason is that it is predicted that the vehicle speed will be a threshold (e.g. 100 km/h) or more, audio guidance saying “Automated drive cannot be executed if the travel speed is further increased. Keep the speed at ◯◯km/h or less.” is generated. In the case where the non-execution reason is that it is predicted that the vehicle will enter a section that requires the vehicle to make a lane change and a lane change cannot be made through the automated drive control in the section, audio guidance saying “The vehicle is heading for ◯◯. Automated drive may not be executed because of the heavy traffic. If automated drive is stopped, change to the left lane and execute automated drive again.” is generated. An image for guidance that instructs a lane change is also generated. In the case where the non-execution reason is that it is predicted that the vehicle will enter a section in which a partition line (such as a roadway center line, a lane boundary line, and a roadway outer line) of the lane in which the vehicle travels (not all lanes) has disappeared or faded to such a degree that the partition line cannot be recognized using a camera, an audio content saying “Automated drive may not be executed because of the poor lane condition ahead. If automated drive is stopped, change to the right lane and execute automated drive again.” is generated. An image for guidance that instructs a lane change is also generated.

After that, in S29, the CPU 41 executes processing of continuing or starting the automated drive control. In the case where it is determined in S4 that the automated drive control is executed (S4: YES), no particular instruction is provided to the vehicle control ECU 20 in S29. As a result, the automated drive control which is currently performed in the vehicle continues to be executed. In the case where it is determined in S5 that an operation for starting the automated drive control has been performed (S5: YES), meanwhile, the CPU 41 transmits an instruction signal to the vehicle control ECU 20 via a CAN to switch the travel mode of the vehicle from the manual drive based on a drive operation by the user to travel through the automated drive control in S29. As a result, the vehicle control ECU 20 which has received the instruction signal starts processing related to the automated drive control, and the vehicle starts travel through the automated drive control. It should be noted, however, that in the case where the non-execution reason cannot be resolved after that before the vehicle will fall into a situation where the automated drive control cannot be executed, travel through the automated drive control is suspended in S17, and the travel mode of the vehicle is switched to travel through the manual drive (S17). The timing at which the travel mode of the vehicle is switched to travel through the manual drive may be the timing at which the vehicle falls into a situation where the automated drive control cannot be executed, or an earlier timing. If the user executes a drive operation on which guidance is provided in S31 to be discussed later before the vehicle falls into a situation where the automated drive control cannot be executed, meanwhile, the vehicle can avoid falling into a situation where the automated drive control cannot be executed and continuously execute the automated drive control. It should be noted, however, that it is necessary to temporarily cancel the automated drive control during the drive operation.

After that, in S30, the CPU 41 determines whether or not it is the timing to provide guidance. Specifically, it is determined that it is the timing to provide guidance in the case where the vehicle has reached a location a predetermined distance before the location at which the section in which the automated drive control cannot be executed is started. The predetermined distance may be a fixed distance (e.g. 300 m), or may be varied in accordance with the vehicle speed or the road type. A predetermined time (e.g. 10 seconds earlier) may be used instead of the predetermined distance.

In the case where it is determined that it is the timing to provide guidance (S30: YES), the processing proceeds to S31. In the case where it is determined that it is not the timing to provide guidance (S30: NO), in contrast, the processing stands by until the timing to provide guidance comes.

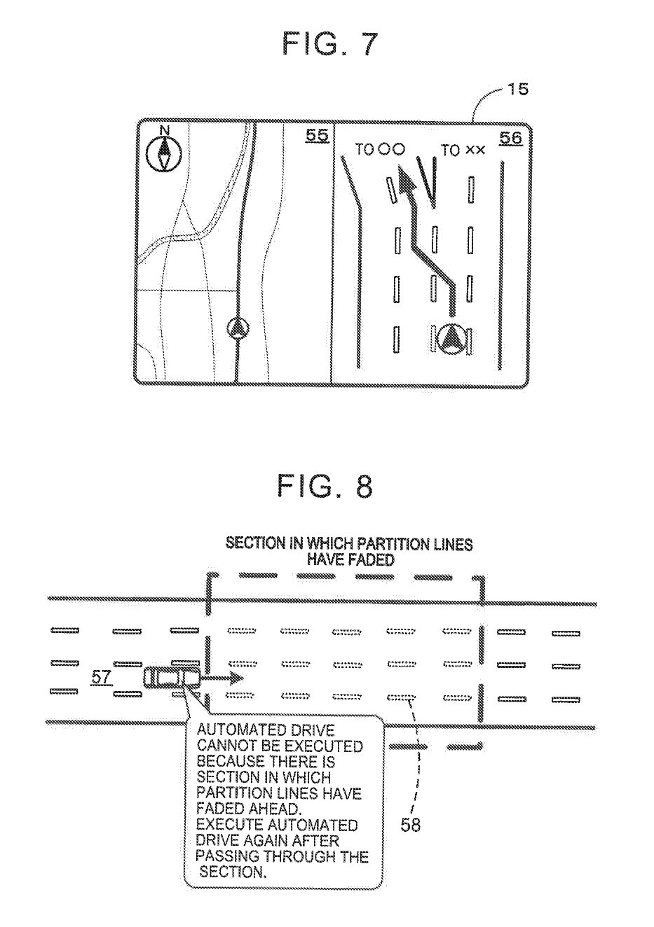

In S31, the CPU 41 outputs the guide content generated in S28 from the liquid crystal display 15 and the speaker 16 to provide guidance indicating that the automated drive control cannot be executed, the non-execution reason acquired in S24, and the drive operation method for avoiding the non-execution reason specified in S27. The specific guide processing is the same as that in S16, and thus is not described (FIGS. 6 and 7).

As a result of providing guidance as described above, the user can understand that the automated drive control may be interrupted. The user can also understand the reason for which the automated drive control cannot be executed. The user can further understand that travel through the automated drive control can be continued by making a drive operation on which guidance is provided before the automated drive control is interrupted, and that travel through the automated drive control can be recovered again by making the drive operation on which guidance is provided even if the automated drive control is interrupted.

In S32, meanwhile, the CPU 41 generates the content of guidance to be provided to the user. Specifically, the guide content is generated so as to indicate that the automated drive control cannot be executed and the non-execution reason acquired in S24. For example, an audio content saying “Automated drive may not be executed because of ◯◯ ahead. Take caution.” is generated.

Next, in S33, the CPU 41 executes processing of continuing or starting the automated drive control. The processing is the same as that in S29, and thus is not described in detail.

After that, in S34, the CPU 41 determines whether or not it is the timing to provide guidance. Specifically, it is determined that it is the timing to provide guidance in the case where the vehicle has reached a location a predetermined distance before the location at which the section in which the automated drive control cannot be executed is started. The predetermined distance may be a fixed distance (e.g. 300 m), or may be varied in accordance with the vehicle speed or the road type. A predetermined time (e.g. 10 seconds earlier) may be used instead of the predetermined distance.

In the case where it is determined that it is the timing to provide guidance (S34: YES), the processing proceeds to S35. In the case where it is determined that it is not the timing to provide guidance (S34: NO), in contrast, the processing stands by until the timing to provide guidance comes.

In S35, the CPU 41 outputs the guide content generated in S32 from the liquid crystal display 15 and the speaker 16 to provide guidance indicating that the automated drive control cannot be executed and the non-execution reason acquired in S24. The specific guide processing is the same as that in S23, and thus is not described (FIG. 10). In S35, it is not determined at present whether or not the automated drive control will be actually interrupted even if the non-execution reason is one of the “(B) reasons that are caused only in a specific section,” and thus guidance on the section in which it is predicted that the automated drive control cannot be executed is not provided. It should be noted, however, that guidance on the section in which it is predicted that the automated drive control cannot be executed may be provided.

As a result of providing guidance as described above, the user can understand that the automated drive control may be interrupted. The user can also understand the reason for which the automated drive control cannot be executed.

With the navigation apparatus 1, the automated drive assisting method performed by the navigation apparatus 1, and the computer program executed by the navigation apparatus 1 according to the embodiment, as described in detail above, in the case where it is determined that the automated drive control cannot be executed at present or in the future during travel in the automated drive section in which the automated drive control for the vehicle is permitted, the non-execution reason which is a reason for which the automated drive control cannot be executed is acquired (S11, S24), and guidance indicating that the automated drive control cannot be executed and the acquired non-execution reason is provided (S16, S21, S23, S31, S35). Thus, it is possible to avoid suspension of the automated drive control by a drive operation by the user, depending on the reason. In addition, the user can grasp under what conditions the automated drive control will be recovered. Thus, travel through the automated drive control can be recovered at an earlier timing even in the case where the automated drive control is suspended, and the timing at which travel through the automated drive control is recovered can be grasped beforehand. Thus, it is possible to reduce the burden for the drive operation on the user, and to enable the vehicle to appropriately travel through the automated drive control.

The embodiment described above is not limiting and various improvements and modifications may be made without departing from the scope and spirit.

For example, in the embodiment, the conditions (1) to (8) are mentioned as examples of the situation where the automated drive control cannot be executed. However, conditions other than the conditions (1) to (8) may also be set. For example, examples of the situation where the automated drive control cannot be executed may include a case where the vehicle is traveling in a section that requires the vehicle to make a lane merge to the main lane but a lane merge cannot be made through the automated drive control and a case where the vehicle travels in a section in which a lane closure has been caused by a fallen object.

In the embodiment, the travel assist processing program (FIGS. 2 to 4) is executed by the navigation apparatus 1. However, the travel assist processing program may be executed by the vehicle control ECU 20. In such a case, the vehicle control ECU 20 acquires the current position of the vehicle, map information, traffic information, and so forth from the navigation apparatus 1. Alternatively, only the processes in S10, S17, S29, and S33 related to the automated drive control may be executed by the vehicle control ECU 20.

In the embodiment, automated drive control for automatic travel, which does not rely on drive operations by the user, has been described as control in which the vehicle control ECU 20 controls all the operations including an accelerator operation, a brake operation, and a steering operation, which are related to the behavior of the vehicle, among operations on the vehicle. However, automated drive control may be control in which the vehicle control ECU 20 controls at least one of the operations including an accelerator operation, a brake operation, and a steering operation, which are related to the behavior of the vehicle, among operations on the vehicle. On the other hand, manual drive, which relies on drive operations by the user, is described as drive in which the user performs all of the operations including an accelerator operation, a brake operation, and a steering operation, which are related to the behavior of the vehicle, among operations on the vehicle.

The above-described principles can be applied to devices that have a function of providing guidance on travel along a route for guidance, besides the navigation apparatus. For example, the principles may also be applied to devices such as a cellular phone, a smartphone, a tablet terminal, and a personal computer (hereinafter referred to as a portable terminal etc.). The above-described principles may also be applied to a system composed of a server and a portable terminal etc. In this case, each step of the travel assist processing program (FIGS. 2 to 4) discussed above may be performed by any of the server and the portable terminal etc. It should be noted, however, that in the case where the above-described principles are applied to the portable terminal etc., it is necessary that the vehicle which can be subjected to the automated drive control and the portable terminal etc. should be connected so as to communicate with each other (either through a wire or wirelessly).

While an automated drive assisting system according to a specific embodiment has been described above, the automated drive assisting system may be configured as described below, and the following effect can be achieved in such cases.

For example, a first configuration is as follows.

The system is characterized by including: non-execution reason acquisition means for acquiring a non-execution reason, for which automated drive control cannot be executed, in the case where the automated drive control cannot be executed during travel in an automated drive section in which the automated drive control for a vehicle is permitted; and non-execution reason guide means for providing guidance on the non-execution reason acquired by the non-execution reason acquisition means.

With the automated drive assisting system configured as described above, guidance on a reason for which automated drive control cannot be executed is provided in the case where the automated drive control cannot be executed, and thus it is possible to avoid suspension of the automated drive control by a drive operation by a user, depending on the reason. In addition, the user can grasp under what conditions the automated drive control will be recovered. Thus, travel through the automated drive control can be recovered at an earlier timing even in the case where the automated drive control is suspended, and the timing at which travel through the automated drive control is recovered can be grasped beforehand. Thus, it is possible to reduce the burden for the drive operation on the user, and to enable the vehicle to appropriately travel through the automated drive control.

A second configuration is as follows.

The system is characterized by further including: avoidable reason determination means for determining whether or not the non-execution reason is a reason that is avoidable by a drive operation by a driver of the vehicle; and avoiding operation guide means for providing, in the case where it is determined by the avoidable reason determination means that the non-execution reason is a reason that is avoidable by a drive operation by the driver, guidance on a drive operation for avoiding the reason.

With the automated drive assisting system configured as described above, guidance on a drive operation for avoiding the reason for which the automated drive control cannot be executed is provided in the case where the automated drive control cannot be executed. Thus, the user can avoid suspension of the automated drive control by executing the drive operation on which guidance has been provided. In addition, travel through the automated drive control can be recovered at an earlier timing by executing the drive operation on which guidance has been provided even in the case where the automated drive control is suspended.

A third configuration is as follows.

The system is characterized by further including non-execution guide means for providing guidance indicating that the automated drive control cannot be executed in the case where it is determined by the avoidable reason determination means that the non-execution reason is not a reason that is avoidable by a drive operation by the driver.

With the automated drive assisting system configured as described above, guidance indicating that the automated drive control cannot be executed is provided, in addition to guidance on the reason for which the automated drive control cannot be executed, in the case where the automated drive control cannot be executed for a reason that is not avoidable by a drive operation by the driver. Thus, the user can understand that the automated drive control cannot be executed for a while.

A fourth configuration is as follows.

The system is characterized in that the avoidable reason determination means determines that the non-execution reason is a reason that is avoidable by a drive operation by the driver of the vehicle in the case where a vehicle speed of the vehicle is a threshold or more, in the case where a lane change cannot be made through the automated drive control in a section that requires the vehicle to make a lane change, or in the case where some partition lines of lanes are not detectable.

With the automated drive assisting system configured as described above, it is possible to accurately specify whether or not the reason for which the automated drive control cannot be executed is a reason that is avoidable by a drive operation by the driver in the case where a situation in which the automated drive control cannot be executed occurs at present or will occur in the future.

A fifth configuration is as follows.

The system is characterized by further including: section reason determination means for determining whether or not the non-execution reason is a reason that is caused only in a specific section; and section guide means for providing, in the case where it is determined by the section reason determination means that the non-execution reason is a reason that is caused only in a specific section, guidance on the specific section.

With the automated drive assisting system configured as described above, the user can understand that the automated drive control is temporarily interrupted. Furthermore, guidance on the section in which the automated drive control cannot be executed is provided. Thus, the timing at which travel through the automated drive control can be recovered can be grasped beforehand.

A sixth configuration is as follows.

The system is characterized in that the section reason determination means determines that the non-execution reason is a reason that is caused only in a specific section in the case where the vehicle travels on a road in a specific shape that does not allow execution of the automated drive control, in the case where the vehicle travels in an accident section or a road work section, or in the case where all partition lines of lanes are not detectable.

With the automated drive assisting system configured as described above, it is possible to accurately specify whether or not the reason for which the automated drive control cannot be executed is a reason that is caused only in a specific section in the case where a situation in which the automated drive control cannot be executed occurs at present or will occur in the future.

A seventh configuration is as follows.

The system is characterized in that the non-execution reason acquisition means acquires the non-execution reason in the case where it is determined that the vehicle has fallen into a situation where the automated drive control cannot be executed while the vehicle is traveling through the automated drive control in the automated drive section.

With the automated drive assisting system configured as described above, guidance on the reason for which the automated drive control cannot be executed is provided in the case where the vehicle falls into a situation where the automated drive control cannot be executed while the vehicle is traveling through the automated drive control in the automated drive section. Thus, the user can grasp under what conditions the automated drive control will be recovered even in the case where the automated drive control is interrupted. Thus, travel through the automated drive control can be recovered at an earlier timing.

An eighth configuration is as follows.

The system is characterized by further including automated drive interruption means for switching a travel mode of the vehicle from travel through the automated drive control to manual drive based on a drive operation by a driver in the case where it is determined that the vehicle has fallen into a situation where the automated drive control cannot be executed while the vehicle is traveling through the automated drive control in the automated drive section; in the case where the non-execution reason is a reason that is avoidable by a drive operation by the driver of the vehicle, travel through the automated drive control is recovered after the non-execution reason is avoided by the drive operation by the driver; and in the case where the non-execution reason is a reason that is caused only in a specific section, travel through the automated drive control is recovered after the vehicle passes through the specific section.

With the automated drive assisting system configured as described above, in the case where the vehicle falls into a situation where the automated drive control cannot be executed while the vehicle is traveling through the automated drive control in the automated drive section, the automated drive control is recovered after the reason for which the automated drive control cannot be executed is resolved. Thus, it is possible to switch between travel through the automated drive control and travel through the manual drive at an appropriate timing in accordance with the situation.

A ninth configuration is as follows.

The system is characterized by further including travel switching means for switching a travel mode of the vehicle from manual drive based on a drive operation by a driver to travel through the automated drive control; and the non-execution reason acquisition means acquires the non-execution reason in the case where it is determined that the vehicle is in a situation where the automated drive control cannot be executed when switching is made from the manual drive to travel through the automated drive control during travel in the automated drive section.

With the automated drive assisting system configured as described above, guidance on the reason for which the automated drive control cannot be executed is provided in the case where the vehicle is in a situation where the automated drive control cannot be executed when the travel mode of the vehicle is switched from the manual drive based on a drive operation by the user to travel through the automated drive control. Thus, the user can grasp under what conditions switching can be made even in the case where switching to the automated drive control cannot be made. Thus, travel through the automated drive control can be started at an earlier timing.

A tenth configuration is as follows.

The system is characterized in that in the case where the non-execution reason is a reason that is avoidable by a drive operation by the driver of the vehicle, switching is made to travel through the automated drive control after the non-execution reason is avoided by the drive operation by the driver; and in the case where the non-execution reason is a reason that is caused only in a specific section, switching is made to travel through the automated drive control after the vehicle passes through the specific section.

With the automated drive assisting system configured as described above, in the case where the vehicle falls into a situation where the automated drive control cannot be executed when the travel mode of the vehicle is switched from the manual drive based on a drive operation by the driver to travel through the automated drive control, the automated drive control is started after the reason for which the automated drive control cannot be executed is resolved. Thus, it is possible to switch between travel through the automated drive control and travel through the manual drive at an appropriate timing in accordance with the situation.

An eleventh configuration is as follows.

The system is characterized in that the non-execution reason acquisition means acquires the non-execution reason, which is predicted, in the case where it is predicted that the vehicle will fall into a situation where the automated drive control cannot be executed at a location ahead in a travel direction of the vehicle which travels through the automated drive control in the automated drive section.

With the automated drive assisting system configured as described above, guidance on the predicted reason for which the automated drive control cannot be executed is provided in the case where it is predicted that the vehicle will fall into a situation where the automated drive control cannot be executed in the future when the vehicle travels through the automated drive control in the automated drive section. Thus, suspension of the automated drive control can be avoided beforehand by a drive operation by the user or the like. In addition, the user can grasp under what conditions the automated drive control will be recovered even in the case where the automated drive control is suspended. Thus, travel through the automated drive control can be recovered at an earlier timing.

A twelfth configuration is as follows.

The system is characterized in that in the case where the non-execution reason is a reason that is avoidable by a drive operation by a driver of the vehicle, travel through the automated drive control is continued if the non-execution reason is avoided by the drive operation by the driver before the vehicle falls into a situation where the automated drive control cannot be executed, and a travel mode of the vehicle is switched from travel through the automated drive control to manual drive by the drive operation by the driver in the case where the non-execution reason is not avoided; and in the case where the non-execution reason is not a reason that is avoidable by a drive operation by a driver of the vehicle, the travel mode of the vehicle is switched from travel through the automated drive control to the manual drive by the drive operation by the driver before the vehicle falls into a situation where the automated drive control cannot be executed.

With the automated drive assisting system configured as described above, in the case where it is predicted that the vehicle will fall into a situation where the automated drive control cannot be executed in the future when the vehicle travels through the automated drive control in the automated drive section, the automated drive control is suspended in the case where the reason for which the automated drive control cannot be executed is not resolved after that, and the automated drive control is continued in the case where the reason for which the automated drive control cannot be executed can be resolved. Thus, it is possible to switch between travel through the automated drive control and travel through the manual drive at an appropriate timing in accordance with the situation.

1. An automated drive assisting system comprising:
a processor programmed to:
acquire a non-execution reason, for which automated drive control cannot be executed, in the case where the automated drive control cannot be executed during travel in an automated drive section in which the automated drive control for a vehicle is permitted;
provide guidance on the acquired non-execution reason;
determine whether or not the non-execution reason is a reason that is avoidable by a drive operation by a driver of the vehicle; and
provide, in the case where it is determined that the non-execution reason is a reason that is avoidable by a drive operation by the driver, guidance on a drive operation for avoiding the reason.

2. (canceled)

3. The automated drive assisting system according to claim 1, wherein the processor is programmed to:
provide guidance indicating that the automated drive control cannot be executed in the case where it is determined that the non-execution reason is not a reason that is avoidable by a drive operation by the driver.

4. The automated drive assisting system according to claim 1, wherein the processor is programmed to:
determine that the non-execution reason is a reason that is avoidable by a drive operation by the driver of the vehicle in the case where:
a vehicle speed of the vehicle is a threshold or more,
a lane change cannot be made through the automated drive control in a section that requires the vehicle to make a lane change, or
some partition lines of lanes are not detectable.

5. The automated drive assisting system according to claim 1, wherein the processor is programmed to:
determine whether or not the non-execution reason is a reason that is caused only in a specific section; and
provide, in the case where it is determined that the non-execution reason is a reason that is caused only in a specific section, guidance on the specific section.

6. The automated drive assisting system according to claim 5, wherein the processor is programmed to:
determine that the non-execution reason is a reason that is caused only in a specific section in the case where:
the vehicle travels on a road in a specific shape that does not allow execution of the automated drive control,
the vehicle travels in an accident section or a road work section, or
all partition lines of lanes are not detectable.

7. The automated drive assisting system according to claim 1, wherein the processor is programmed to:
acquire the non-execution reason in the case where it is determined that the vehicle has fallen into a situation where the automated drive control cannot be executed while the vehicle is traveling through the automated drive control in the automated drive section.

8. The automated drive assisting system according to claim 7, wherein:
the processor is programmed to switch a travel mode of the vehicle from travel through the automated drive control to manual drive based on a drive operation by a driver in the case where it is determined that the vehicle has fallen into a situation where the automated drive control cannot be executed while the vehicle is traveling through the automated drive control in the automated drive section;
in the case where the non-execution reason is a reason that is avoidable by a drive operation by the driver of the vehicle, travel through the automated drive control is recovered after the non-execution reason is avoided by the drive operation by the driver; and
in the case where the non-execution reason is a reason that is caused only in a specific section, travel through the automated drive control is recovered after the vehicle passes through the specific section.

9. The automated drive assisting system according to claim 1, wherein the processor is programmed to:
switch a travel mode of the vehicle from manual drive based on a drive operation by a driver to travel through the automated drive control; and
acquire the non-execution reason in the case where it is determined that the vehicle is in a situation where the automated drive control cannot be executed when switching is made from the manual drive to travel through the automated drive control during travel in the automated drive section.

10. The automated drive assisting system according to claim 9, wherein:
in the case where the non-execution reason is a reason that is avoidable by a drive operation by the driver of the vehicle, switching is made to travel through the automated drive control after the non-execution reason is avoided by the drive operation by the driver; and
in the case where the non-execution reason is a reason that is caused only in a specific section, switching is made to travel through the automated drive control after the vehicle passes through the specific section.

11. The automated drive assisting system according to claim 1, wherein the processor is programmed to:
acquire, the non-execution reason, which is predicted, in the case where it is predicted that the vehicle will fall into a situation where the automated drive control cannot be executed at a location ahead in a travel direction of the vehicle which travels through the automated drive control in the automated drive section.

12. The automated drive assisting system according to claim 11, wherein:
in the case where the non-execution reason is a reason that is avoidable by a drive operation by a driver of the vehicle, travel through the automated drive control is continued if the non-execution reason is avoided by the drive operation by the driver before the vehicle falls into a situation where the automated drive control cannot be executed, and a travel mode of the vehicle is switched from travel through the automated drive control to manual drive by the drive operation by the driver in the case where the non-execution reason is not avoided; and
in the case where the non-execution reason is not a reason that is avoidable by a drive operation by a driver of the vehicle, the travel mode of the vehicle is switched from travel through the automated drive control to the manual drive by the drive operation by the driver before the vehicle falls into a situation where the automated drive control cannot be executed.

13. An automated drive assisting method comprising:
acquiring a non-execution reason, for which automated drive control cannot be executed, in the case where the automated drive control cannot be executed during travel in an automated drive section in which the automated drive control for a vehicle is permitted;
providing guidance on the acquired non-execution reason;
determining whether or not the non-execution reason is a reason that is avoidable by a drive operation by a driver of the vehicle; and
providing, in the case where it is determined that the non-execution reason is a reason that is avoidable a drive operation by the driver, guidance on a drive operation for avoiding the reason.

14. A computer-readable storage medium storing a computer-executable automated drive assisting program that causes a computer to perform the following functions:
acquiring a non-execution reason, for which automated drive control cannot be executed, in the case where the automated drive control cannot be executed during travel in an automated drive section in which the automated drive control for a vehicle is permitted; and
providing guidance on the acquired non-execution reason;
determining whether or not the non-execution reason is a reason that is avoidable by a drive operation by a driver of the vehicle; and
providing, in the case where it is determined that the non-execution reason is a reason that is avoidable by a drive operation by the driver, guidance on a drive operation for avoiding the reason.
